(19) United States
(12) Patent Application Publication
(10) Pub. No.: US 2003/0055921 A1
(43) Pub. Date: Mar. 20, 2003

(54) Method and apparatus for reengineering legacy systems for seamless interaction with distributed component systems

(76) Inventors: Vinay Vasant Kulkarni, Pune (IN); Sreedhar Sannareddy Reddy, Pune (IN)

Correspondence Address: CENTRAL COAST PATENT AGENCY, PO BOX 187, AROMAS, CA, 95004, US

(21) Appl. No.: 10/038,012

(22) Filed: Jan. 2, 2002

(30) Foreign Application Priority Data
Aug. 21, 2001 (IN) 810/MUM/2001

(51) Int. Cl. G06F 15/177; G06F 15/16

(52) U.S. Cl. 709/220; 709/250

(57) ABSTRACT

System architecture is taught for adapting at least one legacy system for functional interface with at least one component system. The architecture includes a data reconciliation bus for enabling reconciliation of redundant data between legacy systems, at least one component wrapper within the architecture for describing a legacy system, at least one component object within the architecture for describing a component system, and a connectivity bus within the architecture between at least one component object and at least one component wrapper, the bus for extending legacy function to the at least one component system. In a preferred embodiment, a user operating a GUI has access to legacy services in an automated client/server exchange wherein heterogeneous data formats and platform differences of the separate systems are resolved in an object-oriented way that is transparent to the user.

### FIELD OF THE INVENTION

The present invention is in the field of computerized information systems and pertains in particular to an enhanced system for reengineering legacy systems to communicate with distributed component systems.

### CROSS-REFERENCE TO RELATED DOCUMENTS

The present patent application claims priority to Foreign provisional patent application serial number 810/MUM/2001 filed in India on Aug. 21, 2001. The prior application is incorporated herein in its entirety by reference.

### BACKGROUND OF THE INVENTION

Large businesses and organizations typically consolidate all of their important data using computerized information systems. A legacy system is loosely defined as any information system that, by nature of its architecture and software structure, significantly resists system evolution or change. Typically, legacy systems fall under the category of relational database management systems (RDBMS), which run on mainframe or minicomputers.

Legacy systems typically form the main portion of information flow for an organization, and usually are the main vehicles for information consolidation for the host business or organization. Loosely defined attributes of a legacy system include being hosted on old or even obsolete hardware that is computationally slow and prone to expensive maintenance. Likewise, the software of a legacy system is generally not well understood and is often poorly documented. Therefore integration of legacy systems to newer software/hardware information systems or peripheral systems is burdensome, due to lack of clean interfaces. Adapting a legacy system to provide state-of-art function according to today's computational standards is extremely risky and burdensome using prior art techniques. Many prior art techniques are not proven and are still, at the time of this writing, a subject of considerable ongoing research.

As companies mature and evolve, it becomes important to be able to adapt their computing and information processing capabilities to a more competitive, technologically advanced, and fast-paced environment. But because their legacy systems are critical components to their continued success, much effort and expense must be undertaken in attempting to either completely rewrite the legacy systems or to attempt to move or migrate the system data and function into a more efficient, functional and cost-effective computer environment.

Rewriting a legacy system from scratch is usually not a viable option, because of the inherent liabilities of the system, the risk of failures, data loss, and poor understanding of how the system actually performs internally. Legacy systems are by design closed architectures and are not readily compatible with today's software and hardware architectures. Most organizations prefer to migrate their legacy systems to more efficient and easily maintainable target environments. This is called system migration in the art. System migration is an attempt to salvage the functionality of and data integrity within a legacy system as well as to enable added functionality to the system without having to redevelop the entire system. System migration implies that once a legacy system has been migrated to a target system, the legacy environment may then be shut down completely.

The most common state-of-art technique for legacy system migration is the use of a connectivity or middleware software such as the well-known CORBA (Common Object Request Broker Architecture). CORBA is just one of several major distributed object-oriented infrastructures.

The design of CORBA is based on the OMG Object Model. The OMG Object Model defines common object semantics for specifying externally visible characteristics of objects in a standard and implementation-independent way. In this model clients request services from objects, also sometimes called servers, through a well-defined and clean interface. A client accesses an object (server) by issuing a request to the object. The request is an event, and it carries information including an operation, the object reference of the service provider, and any actual parameters. The object reference equates to an object name that defines an object reliably. Another common framework used as middleware in legacy system migration is the well-known object linking and embedding/common object modeling (OLE/COM).

Conventions such as CORBA and other component-based frameworks can be effective in allowing component objects to discover each other and interoperate across networks. Generally speaking however, direct usage of any of these middleware softwares in system migration is quite expensive, and as an art in itself is fraught with ad hoc procedures and high component failure possibilities. Few migration frameworks can claim even limited success.

What is clearly needed is a method and apparatus for reengineering legacy systems for seamless bi-directional interaction with distributed component systems and for unifying data between more than one integrated legacy system. A system such as this would enable reliable system integration and enhancement to legacy functionality without requiring significant system redevelopment or system migration using closed middleware solutions.

### SUMMARY OF THE INVENTION

In a preferred embodiment of the present invention a system architecture for adapting at least one legacy system for functional interface with at least one component system is provided, comprising a data reconciliation bus for data redundancy between legacy systems in the event of more than one legacy system, at least one component wrapper within the architecture for describing the at least one legacy system, at least one component object within the architecture for describing the at least one component system, and a connectivity bus within the architecture between the at least one component object and the at least one component wrapper, for extending legacy function to the at least one component system. The system is characterized in that a user operating a GUI has access to legacy services in an automated client/server exchange wherein heterogeneous data formats and platform differences of the separate systems are resolved in an object-oriented way that is transparent to the user.

In a preferred embodiment one component is interfaced with more than one legacy system in the event of more than one system, and in another preferred embodiment one legacy system is interfaced with more than one component system in the event there is more than one component system.

In some embodiments the data reconciliation bus utilizes an in memory entity-relationship model of each legacy system of the architecture. Further, entity-relationship modeling may be used to model legacy services. In some cases a component wrapper is completely generated from an object model of legacy services. Still further, heterogeneity of data between a legacy system and a component wrapper may be resolved by a language adapter interface.

In another aspect of the invention a method for adapting at least one legacy system for functional interface with at least one component system is provided, comprising steps of (a) identifying the functionality of the at least one legacy system in terms of external expectations of the system; (b) specifying individual services and aggregating them into a modeled set of services; (c) generating an object facade from the service model that describes the aggregated legacy services; (d) providing a component object that describes the functionality of the component system; and (e) defining a mapping between the object facade and the component object.

In some preferred embodiments, in step (b), services are expressed as n-tuples. In some others, in step (b), the service sets are modeled using object modeling. In step (c) the service model may be an object model. Further, in step (d), the component object may be developed specifically for a corresponding object facade.

In yet another aspect of the invention, in a system architecture for integrating legacy systems and component systems, a data reconciliation framework for achieving data reconciliation between redundant data elements in the legacy systems is provided, comprising a memory component with a data model stored therein, the data model describing all legacy systems data and component systems data, a first function for propagating data from a legacy system, and a second function for propagating data to a legacy system or systems. The framework is characterized in that the first function updates the data model and the second function takes the update from the data model as input and propagates it to the appropriate system or systems.

In some preferred embodiments the data model stored in memory is a unified normalized layer. Further, the first and second functions may be automated, or in other user-executed. Preferably the functions propagate data in an object oriented environment.

### BRIEF DESCRIPTION OF THE DRAWING FIGURES

FIG. 1 is a block diagram illustrating an architectural overview of an object-oriented system enabling coexistence between legacy systems and state-of-art components according to an embodiment of the present invention.

FIG. 2 is a block diagram illustrating the components and attributes of an object facade for wrapping a legacy system according to an embodiment of the present invention.

FIG. 3 is a block diagram illustrating components and attributes of a data reconciliation bus according to an embodiment of the present invention.

FIG. 4 is a block diagram illustrating tool support for system automation according to an embodiment of the present invention.

FIG. 5 is a process flow chart illustrating process steps for wrapping a legacy system as an object facade.

### DESCRIPTION OF THE PREFERRED EMBODIMENTS

A goal of the present invention is to provide a comprehensive approach for integrating legacy systems to distributed component systems as opposed to complete system rewrites or migrations. The solution provided by the inventor addresses three main problem areas preventing prior-art integration of legacy systems with new components. The first of these problem areas is that there is currently no known middleware-independent (open) framework for interfacing legacy systems with new components. Secondly, there is no known technique for integrating a legacy system or systems within component development frameworks. Finally, there is no practical method of data reconciliation across multiple disconnected legacy systems.

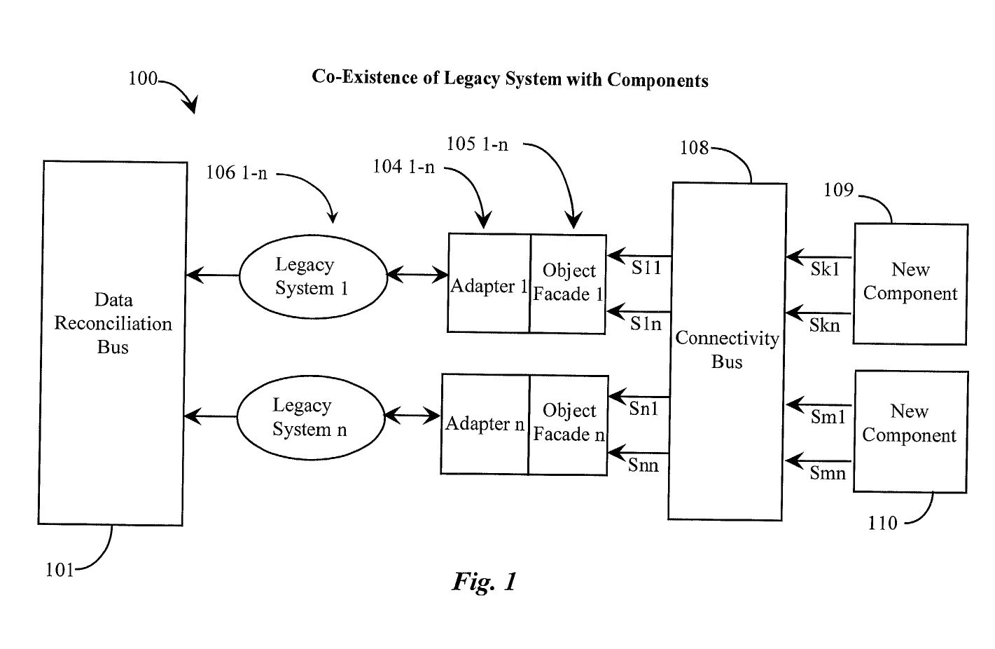

A goal of the present invention is to provide an integration solution enabling continued use and enhancement of enterprise legacy systems, the solution comprising primarily of an open, distributed, and platform-agnostic component architecture (see FIG. 1) enabling the co-existence of existing legacy systems with component-oriented distributed systems. A solution includes a novel technique for wrapping a legacy system as a component object and a technique for optimizing existing function of a legacy system and minimizing disuse or component obfuscation of the legacy system. Still other mission-critical improvements include provision of a generic connectivity bus and a novel data reconciliation bus for addressing redundancy issues between multiple legacy systems as well as tools automating the system integration process.

FIG. 1 is a block diagram illustrating an architectural overview of an object-oriented system 100 enabling coexistence between existing legacy systems and state-of-art components according to an embodiment of the present invention. System 100 is provided as an object-oriented architecture and adapted, in this case, to facilitate functional integration of multiple legacy systems illustrated herein as legacy systems 106 1-n with multiple, distributed components illustrated herein as components 109 and 110.

System 100 incorporates component wrappers for each legacy system 1-n illustrated herein as object facades 105 1-n. Object facades 105 1-n correspond to legacy systems 106 1-n. An object façade is a package that contains references to model elements. The main purpose or goal of an object facade is to represent a legacy system as an abstract object model that provides a defined plurality of services expected of the system from an external environment. A single legacy service can be defined as an n-tuple consisting of a name, at least one input parameter, and at least one output parameter. It is assumed in this example that legacy systems being reengineered utilize RDBMSs.

In this example of multiple legacy systems, a transaction boundary may be assumed to extend across multiple legacy systems 106 1-n. Therefore, RDBMSs inherent to those legacy systems must be XA compliant. XA is one of several available standards known in the art for facilitating distributed transaction management between a transaction manager and a resource manager.

Each object facade 105 1-n in this example has integrated therewith an adapter illustrated in this embodiment as adapters 104 1-n (one per instance). An adapter is responsible for handling data transformation from the closed (private) environment of an associated legacy system to an open (public) environment of object-oriented architecture 100. That is to say that closed language format inherent to the legacy systems is converted to an open non-proprietary format for output distribution to new components 109 and 110 and the open format of those systems is converted by the adapter into the closed legacy formats inherent to the legacy systems for input into those systems. It is noted herein that each adapter is unique to an associated legacy system because of disparate data formats common among disconnected systems.

A unique data-reconciliation bus structure 101 is provided in this embodiment as part of system 100 and is adapted to provide a solution to data redundancy across disconnected legacy systems 106 1-n. For example, if there are data entries in a table owned by legacy system 106 1, but not in the same table existing in but not owned by legacy system 106 n, the redundant data has to be propagated to legacy system 106 n. Likewise, data entries existing in a table owned by legacy system 106 n, but not existing in the same table existing in but not owned by legacy system 106 1 have to be propagated to legacy system 106 1. Data reconciliation across multiple legacy systems 106 1-n can be performed in a batch process. Data reconciliation across multiple legacy systems facilitates better consistency in modeling distinct legacy services.

A connectivity bus 108 is provided as part of system 100 and is adapted to transform object-oriented data in an open format into data formats usable by new components 109 and 110. Likewise, data input from new components 109 and 110 is transformed into object-oriented data in an open format definable at the middleware level of object facade.

Connectivity bus framework expressed in most basic form is represented in syntax as follows:

Class Connector
{
public:

// API to invoke a service in synchronous manner
virtual ErrorStatus callService ( Request *svcName ) = 0;
// API for obtaining input parameters of a service
virtual ErrorStatus getParamsFromBuffer( DArray *in );
// API for returning from a service
virtual ErrorStatus returnAcrossNetwork (Response * svcName );
// API for obtaining return values of a service
virtual ErrorStatus returnedFromService (Darray *out );
// API to invoke a service in asynchronous manner
virtual ErrorStatus callAService ( Request *svcName, Token
&token );
// API to invoke a service in queued manner
virtual ErrorStatus callQService ( Request *svcName Queue *inQ );
// API to poll a service invoked in asynchronous manner
virtual ErrorStatus checkReply ( Token *token );
// API to poll a queue
virtual ErrorStatus checkStatus ( Queue *inQ, Qstatus &qs );
};

Class Request
{
private:

| | |
|---|---|
| char *svcName; | |
| TxnInfo *tinfo; | // Transaction information |

| | |
|---|---|
| Darray *in; | // Darray of input parameters |

Public:

Char * getSvcName();
Void setSvcName( char *name );
TxnInfo *getTxnInfo();
Void setTxnInfo( TxnInfo *ti );
ErrorStatus AddParam( Object *p );
Int sizeof();
Void serialise( char *buf );
Void unserialise( char *buf );

};
Class Response
{
private:

| | |
|---|---|
| char *svcName; | |
| ErrorStatus status; | // Status of invocation |
| Darray *out; | // Darray of return values (in/out + out) |
| Darray *errs; | // Darray of (application) error objects |

Public:

Char * getSvcName();
Void setSvcName( char *name );
ErrorStatus *getStatus();
Void setStatus( ErrorStatus st );
ErrorStatus AddParam( Object *p );
ErrorStatus AddError( Object *e );
Int sizeof();
Void serialise( char *buf );
Void unserialise( char *buf );

};

Connectivity bus 108 can be any standard middleware. In this example, new component 109 accesses services modeled in facade 105 1. Any of Sk1-Skn may invoke any of legacy services 1-n. Connectivity bus 108 resolves the requests to S 11 through S 1n as represented in the component wrapper (façade 105 1). Adapter 104 1 provides the defined set of legacy services in the form of modeled services S 11-S 1n. In this way, new components have integrated access to legacy data through an open (public) architecture.

A key process identified and facilitated by system 100 is the ability to define a legacy system, rather, all of the services to be invoked from external world, as an object model. First, by modeling individual legacy services and then by modeling a defined reference set of those service objects into an object that completely describes an entire legacy system accomplishes this goal. More detail about modeling legacy system services is provided below.

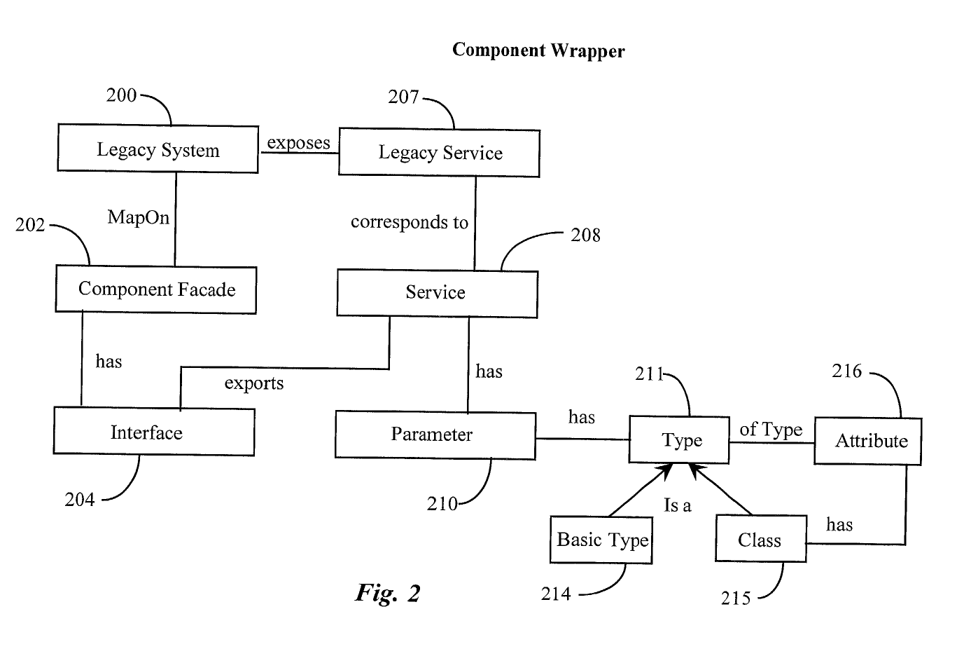

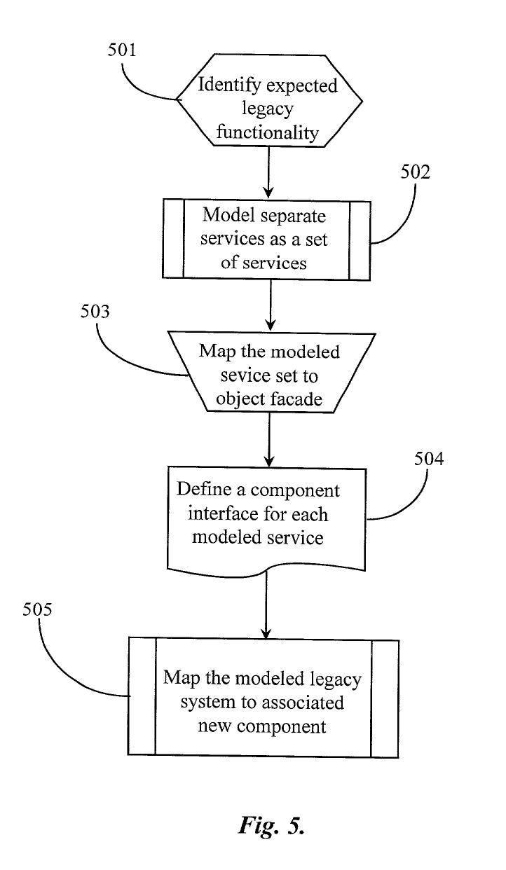

FIG. 2 is a block diagram illustrating the object model of an object facade 105 1-n for wrapping a legacy system to enable interaction with new components according to an embodiment of the present invention. Wrapping a legacy system as an object involves basic steps, which are, in a preferred embodiment, performed in a stated order as described with reference to FIG. 5.

Referring now to FIG. 5, at step 501, functionality of a particular legacy system is identified in terms of expectations of the system from an external environment. At step 502, individual services of the legacy system are identified, aggregated and then specified as a set of services in the type system of the particular legacy system. These services are listed as n-tuples representing individual services having a service name, its input parameters and its output parameters. In this regard, a set of services must have clearly defined input and output parameters. Object modeling is utilized to create a service model of a legacy system. At step 503, a modeled service-set (Object model) representing a legacy system is used to generate a component facade having interface operations, which are specific to the individual services defined in step 502. The component façade (object facade) contains references to all service objects.

For each service identified in step 502 an interface operation is defined in the type system of the open component architecture as an n-tuple. An n-tuple has a method name, a set of input parameters, and a set of output parameters as described briefly above. At this stage a functioning object model (object facade) representing a legacy system is completely defined. The interface of the object facade provides access to the legacy system from an external component-oriented environment.

At step 505, the modeled legacy system is mapped from the legacy type system to a type system (object) of component architecture provided or developed to interact with the system. Such a map enables transformation of object functionality from the open facade (legacy) to an object representing the new component architecture. It is noted that the new component may contain additional objects that extend the functionality of the modeled legacy system services and/or objects that provide entirely new functions.

Component objects are developed to correspond to specific legacy object facades and one component may interact with more than one legacy system. Using this basic technique, legacy systems are reengineered into pure server-side components that are devoid of a graphical user interface (GUI). The server-side components are not available for GUI until they are brought into the open architecture where there are well-defined and distinct layers of presentation and business functionality. A driver component as known in the art is provided and adapted to define a control flow over the services and a business realization view in terms of the services wherein the view is a GUI for the reengineered legacy system.

Referring now back to FIG. 2, a legacy system for re-engineering is represented by a block 200 labeled Legacy System. A legacy system exposes at least one legacy service represented herein by a block 207, labeled Legacy service, that can be expressed as an n-tuple. Legacy service 207 corresponds to a modeled service or service object 208. Legacy system 200 is mapped as a set of services onto component facade 202. Component facade 202 has an interface 204, which contains all of the interface operations corresponding to all of the individual legacy services. Interface 204 exports service object 208 upon request, object 208 representing legacy service 207.

Service object 208 has at least one parameter 210, which has a system type represented herein as a block labeled Type and given the element number 211. Type 211 is a Basic Type illustrated herein as a block labeled Basic Type and given the element number 214, or a Class Type illustrated herein as a block labeled Class and given the element number 215. Type 211 is of Type expressed herein as an attribute represented by a block 216 labeled Attribute. Class type 215 has defined attribute 216. A component wrapper as illustrated in this example exactly references a modeled legacy system with respect to all of its capabilities expressed as n-tuples. Object modeling is, in a preferred embodiment, used to model services and generate the object facade from raw legacy services (n tuples).

The component wrapper (object facade) is of the same object Type and object Class as a corresponding new component system (object) as far as the open middleware framework is concerned. Connectivity bus 108 described with reference to FIG. 1 enables transformation of the common 110 object parameters to data formats actually used by the new component system and platform. It is important to note herein that a new component system may be developed as part of the process for extending existing legacy function and/or for providing entirely new functionality. The end result is a legacy system access capability that is user-friendly in terms of input, access and return. Moreover, the transformation of heterogeneous data across the network (from server to client and from client to server) is completely transparent to the user. A user does not have to code for data transformations.

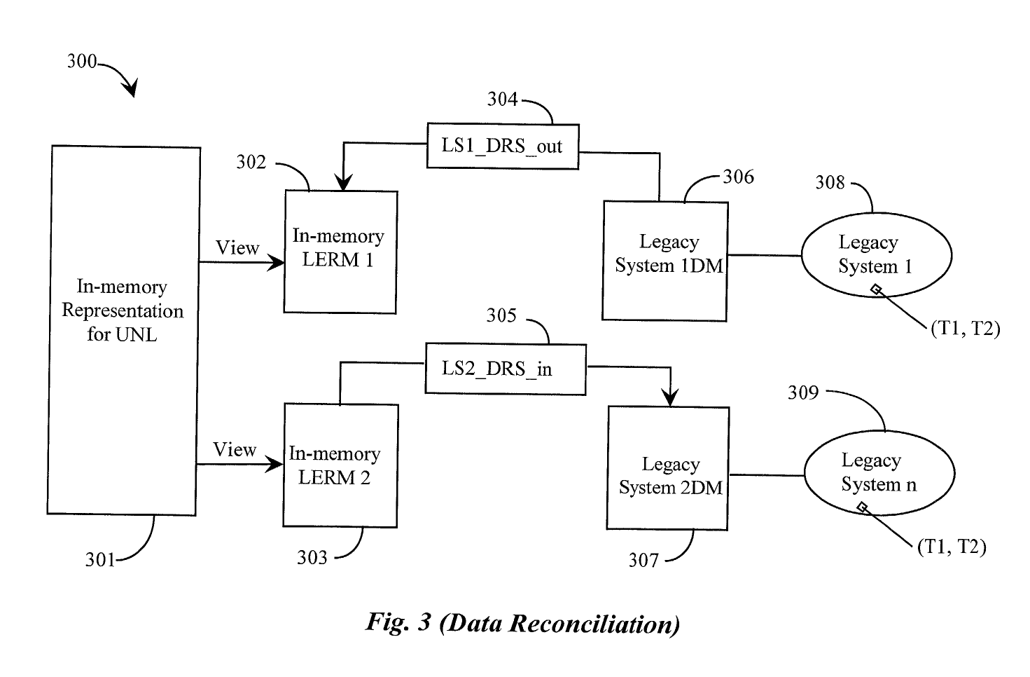

FIG. 3 is a block diagram illustrating logical components and attributes of a novel data-reconciliation bus according to an embodiment of the present invention. The common model for legacy systems and new components interacting with them is represented in memory as a unified and normalized layer (UNL). UNL is a complete data model of the reengineered application including the set of modeled legacy systems as well as the set of modeled new components. Therefore, the UNL data model is devoid of any data redundancies.

Updates to data owned by one legacy system need to be propagated to other legacy systems where the updated data needs to be replicated. Likewise, changes to data not owned by a legacy system need to be propagated to the system from any legacy system owning the data.

A memory block 301 is provided and represents the UNL, which represents the functional part of data bus schema 300. A single data model of a particular legacy system is expressed as an ER model. A legacy ER model is defined as a view over UNL.

In this example, a legacy system 1 (308) and a legacy system 2 (309) have redundant tables T1 and T2 between them such that system 1 (308) owns T1 and system 2 (309) owns T2. Updates of interest to T1 in system 1 need to be propagated to T1 in system 2 and updates of interest to T2 in system 2 need to be propagated to T2 in system 1. A legacy system 1 data model (DM) 306 represents the entire data model for legacy system 1 (308). A Block given the element number 304 represents legacy system 1 (LS1) data reconciliation service (DRS) out. LS1_DRS_out (304) is a user-initiated event for propagating updates of interest to T 1 in system 1 out to UNL. A block labeled LS2_DRS_in (305) is a user-initiated event for propagating the T1 update from UNL into T1 in system 2. It is noted herein that output of block 304 is input to block 305. The redundancy reconciliation is facilitated by an in-memory ER model 1 (LERM 1) 302 and an in-memory LERM 2 (303). The direction of update is illustrated herein by directional arrows from the data model (LDM 1) to the ER model (LERM 1) representing LS1_DRS_out and from the ER model (LERM 2) to the data model (LDM 2) representing LS2_DRS_in. The direction of update for T2 (owned by system 2) would be in reverse order wherein block 305 would read LS2_DRS_out and block 304 would read LSI_DRS_in.

An in-memory view over UNL or LERM 2 (303) from UNL 301 is updated with the required data structures and data. LSR_DRS_in 305 contains the updated data objects from updated LERM 2. These objects are then propagated into LS 2 DM 307 and are incorporated into Legacy system 2 (309) thereby completing a redundancy reconciliation operation between LS 2 and LS 1.

The process mentioned above provides a solution to any undesired data redundancy that may exist or occur in the RDBMSs of multiple disconnected legacy systems being modeled.

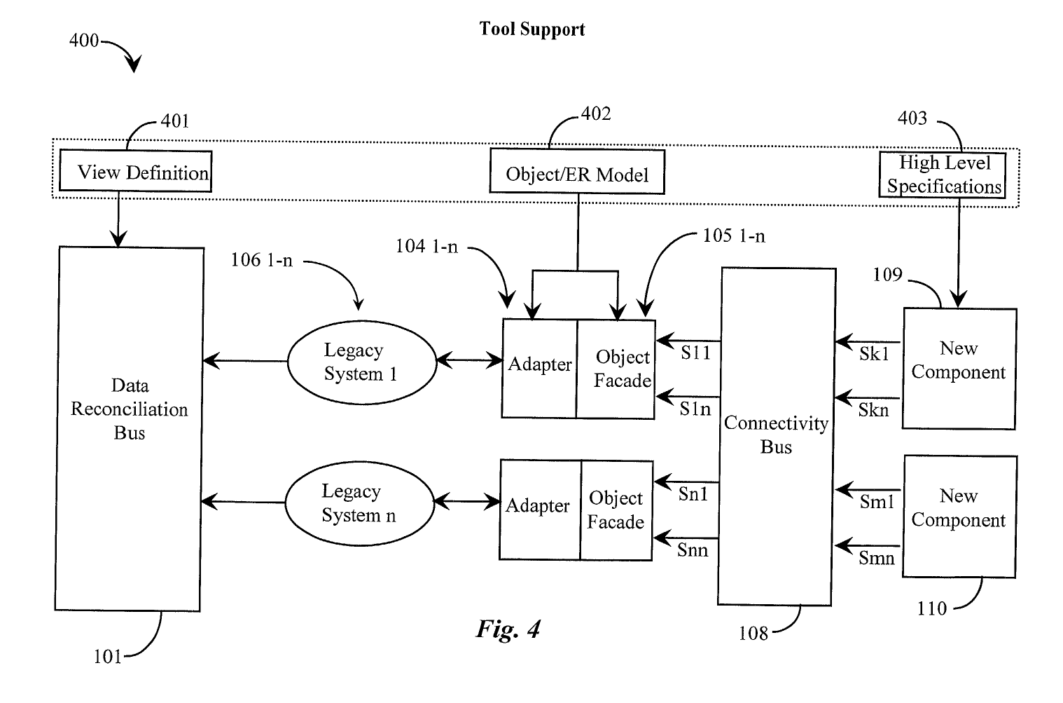

FIG. 4 is a block diagram illustrating tool support for system automation according to an embodiment of the present invention. The architecture of this example is much the same as the architecture described with reference to FIG. 1 above. Therefore, components illustrated in this example that are also present in the example of FIG. 1 retain their element numbers of FIG. 1 and shall not be re-introduced. Tool support for the reengineering system of the present invention includes an object-modeling tool (not shown) for defining object models of new components, services of legacy systems, and interface operations of component facades.

An ER modeling tool 402 is provided and adapted for defining ER models representing individual legacy systems. Object models along with versioning and configuration management parameters are stored in a robust, multi-user object repository (not shown). A high level programming language represented herein by a block labeled High Level Specifications and given the element number 403 is incorporated for specifying mediator functionality between new components and legacy facades. A mechanism is provided for modeling a GUI of a reengineered application and generating user friendly and open GUI.

A block labeled View Definition and given the element number 401 represents a mechanism to define an ER (object) model as a view over UNL and a view over another ER (object) model. In this example object facades and new component object models are completely generated from ER models. Tool support for developing new components that will work with existing legacy systems is available with the inventor.

It will be apparent to one with skill in the art that the approach to reengineering legacy systems to be integrated with new components can be accomplished using the novel embodiments of the invention described herein without requiring closed middleware solutions.

What is claimed is:

1. A system architecture for adapting at least one legacy system for functional interface with at least one component system comprising:
a data reconciliation bus for data redundancy between legacy systems in the event of more than one legacy system;
at least one component wrapper within the architecture for describing the at least one legacy system;
at least one component object within the architecture for describing the at least one component system; and
a connectivity bus within the architecture between the at least one component object and the at least one component wrapper, for extending legacy function to the at least one component system;
characterized in that a user operating a GUI has access to legacy services in an automated client/server exchange wherein heterogeneous data formats and platform differences of the separate systems are resolved in an object-oriented way that is transparent to the user.

2. The system architecture of claim 1 wherein one component is interfaced with more than one legacy system in the event of more than one system.

3. The system architecture of claim 1 wherein one legacy system is interfaced with more than one component system in the event of more than one component system.

4. The system architecture of claim 1 wherein the data reconciliation bus utilizes an in memory entity-relationship model of each legacy system of the architecture.

5. The system architecture of claim 1 wherein entity-relationship modeling is used to model legacy services.

6. The system architecture of claim 5 wherein a component wrapper is completely generated from an object model of legacy services.

7. The system architecture of claim 1 wherein heterogeneity of data between a legacy system and a component wrapper is resolved by a language adapter interface.

8. A method for adapting at least one legacy system for functional interface with at least one component system comprising steps of:
(a) identifying the functionality of the at least one legacy system in terms of external expectations of the system;
(b) specifying individual services and aggregating them into a modeled set of services;
(c) generating an object facade from the service model that describes the aggregated legacy services;
(d) providing a component object that describes the functionality of the component system; and
(e) defining a mapping between the object facade and the component object.

9. The method of claim 8 wherein in step (b) services are expressed as n-tuples.

10. The method of claim 8 wherein in step (b) the service sets are modeled using object modeling.

11. The method of claim 8 wherein in step (c) the service model is an object model.

12. The method of claim 8 wherein in step (d) the component object is developed specifically for a corresponding object facade.

13. In a system architecture for integrating legacy systems and component systems, a data reconciliation framework for achieving data reconciliation between redundant data elements in the legacy systems comprising:
a memory component with a data model stored therein, the data model describing all legacy systems data and component systems data;
a first function for propagating data from a legacy system; and
a second function for propagating data to a legacy system or systems;
characterized in that the first function updates the data model and the second function takes the update from the data model as input and propagates it to the appropriate system or systems.

14. The data reconciliation framework of claim 13 wherein the data model stored in memory is a unified normalized layer.

15. The data reconciliation framework of claim 13 wherein the first and second functions are automated.

16. The data reconciliation framework of claim 13 wherein the first and second functions are user executed.

17. The data reconciliation framework of claim 13 wherein the functions propagate data in an object oriented environment.
